(19) United States
(12) Patent Application Publication
(10) Pub. No.: US 2022/0362876 A1
(43) Pub. Date: Nov. 17, 2022

(54) PLASMA CUTTING METHOD

(71) Applicant: KJELLBERG-STIFTUNG, Finsterwalde (DE)

(72) Inventors: Rene NOGOWSKI, Dresden (DE); Volker KRINK, Finsterwalde (DE); Andre PÖTSCH, Finsterwalde (DE); Thomas STEUDTNER, Fürstenwalde (DE)

(73) Assignee: KJELLBERG-STIFTUNG, Finsterwalde (DE)

(21) Appl. No.: 17/621,633

(22) PCT Filed: Feb. 14, 2020
(86) PCT No.: PCT/DE2020/100104

§ 371 Date: Jul. 22, 2022

(30) Foreign Application Priority Data
Apr. 11, 2019 (DE) 10 2019 002 825.2

(51) Int. Cl. B23K 10/00; B23K 31/00

(52) U.S. Cl. CPC B23K 10/00; B23K 31/003

(57) ABSTRACT

The invention related to a method for plasma cutting workpieces, using a plasma torch that has at least one plasma torch body, an electrode, and a nozzle.

The invention relates to methods and arrangements for plasma cutting workpieces.

Plasma is a thermally highly heated, electrically conductive gas that consists of positive and negative ions, electrons, and excited and neutral atoms and molecules.

Various gases are used as the plasma gas—for example, monatomic argon or helium, and/or the diatomic gases hydrogen, nitrogen, oxygen or air. These gases ionize and dissociate due to the energy of the plasma arc.

The parameters of the plasma jet can be greatly influenced by the design of the nozzle and electrode. These parameters of the plasma jet are, for example, the beam diameter, the temperature, energy density and the flow rate of the gas.

In plasma cutting, for example, the plasma is constricted by a nozzle, which can be gas or water-cooled. For this purpose, the nozzle has a nozzle bore through which the plasma jet flows. This enables energy densities of up to 2×10⁶ W/cm² to be achieved. Temperatures of up to 30,000° C. occur in the plasma jet, which, in conjunction with the high flow rate of the gas, achieve very high cutting speeds on all electrically conductive materials.

Plasma cutting is now an established method for cutting electrically conductive materials. Different gases and gas mixtures are used according to the cutting task.

Plasma torches usually consist of a plasma torch head and a plasma torch shaft. An electrode and a nozzle are attached to the plasma torch head. The plasma gas flows between them and exits through the nozzle bore. Most commonly, the plasma gas is guided through a gas conduit, which is attached between the electrode and the nozzle, and which can be made to rotate. Modern plasma torches also have a feed for a secondary medium, either a gas or a liquid. The nozzle is then surrounded by a nozzle protection cap (also called a secondary gas cap). In particular, in the case of liquid-cooled plasma torches, the nozzle is fixed by a nozzle cap, as described, for example, in DE 10 2004 049 445 A1. The cooling medium then flows between the nozzle cap and the nozzle. The secondary medium then flows between the nozzle or the nozzle cap and the nozzle protection cap, and emerges from the bore of the nozzle protection cap. It affects the plasma jet formed by the arc and the plasma gas. It can be set in rotation by a gas conduit which is arranged between the nozzle or nozzle cap and the nozzle protection cap.

The nozzle protection cap protects the nozzle and the nozzle cap from the heat or from the ejected molten metal of the workpiece, in particular when the plasma jet pierces the material of the workpiece being cut. In addition, it creates a defined atmosphere around the plasma jet when cutting.

For plasma cutting of unalloyed and low-alloy steels, also called structural steels, for example, S235 and S355 as per DIN EN 10027-1, air, oxygen or nitrogen, or a mixture thereof, is usually used as plasma gases. Air, oxygen or nitrogen, or a mixture thereof, is also mostly used as the secondary gas, wherein the composition and volume flows of the plasma gas and the secondary gas are most often different, but can also be the same.

For plasma cutting of high-alloy steels and stainless steels, for example, 1.4301 (X5CrNi10-10) or 1.4541 (X6CrNiTi18-10), the plasma gases used are usually nitrogen, argon, an argon-hydrogen mixture, a nitrogen-hydrogen mixture or an argon-hydrogen-nitrogen mixture. In principle, air can also be used as a plasma gas, but the oxygen content in the air leads to oxidation of the cut faces and thus to a deterioration in the quality of the cut. Nitrogen, argon, an argon-hydrogen mixture, a nitrogen-hydrogen mixture or an argon-hydrogen-nitrogen mixture is also commonly used as the secondary gas, wherein the composition and volume flows of the plasma gas and the secondary gas are most often different, but also can be the same.

In plasma cutting, it is necessary to cut and/or cut out a wide variety of contours—for example, small inner contours, large inner contours and outer contours—in the highest possible quality.

Small contours have a circumferential length that is equal to or less than six times the material thickness and/or a diameter that is equal to or less than twice the material thickness. Large contours have a circumferential length that is more than six times the material thickness, and/or a diameter that is more than twice the material thickness.

In a CNC-controlled guidance system, at least the essential cutting parameters for cutting a material (material type and material thickness) are stored in a database, such as, for example, electrical cutting current, plasma torch distance (distance between the plasma torch tip and the workpiece surface), cutting speed, plasma gas, secondary gas, electrode, nozzle.

The present invention is therefore based on the object of providing a method for plasma cutting workpieces with which the most varied of contours, for example small inner contours, large inner contours and outer contours, can be cut and/or cut out in high quality.

According to a first aspect, this object is achieved by a method for plasma cutting workpieces, in which a plasma cutting torch which has at least one plasma torch body, an electrode, and a nozzle is used for cutting a part from a, in particular, plate-shaped workpiece which has a material thickness, wherein the part of the plasma cutting torch from which a plasma jet emerges from the nozzle forms the plasma torch tip, and in which the plasma cutting torch is guided by means of a guidance system along a contour at a cutting speed v relative to the workpiece surface in the feed direction in such a manner that at least a small inner contour of the part, the circumference of which is less than or equal to six times the material thickness of the workpiece, or the diameter of which is less than or equal to twice the material thickness of the workpiece, is/are cut out, and in such a manner that at least one outer contour of the part and/or a large inner contour of the part, the circumference of which is greater than six times the material thickness of the workpiece or the diameter of which is greater than twice the material thickness of the workpiece, is/are cut out, wherein the plasma torch tip is at a cutting distance from the workpiece surface during cutting, wherein at least a small, or a major, portion of the circumference of the small inner contour being cut from the part is cut at a different cutting distance between the plasma torch tip and the workpiece surface than at least a small, or a major, portion of the circumference of the outer contour of the part being cut, and/or at least one large, or a major portion, of the circumference of the large inner contour of the part being cut.

According to a second aspect, this object is achieved by a method for plasma cutting workpieces, in which a plasma cutting torch which has at least one plasma torch body, an electrode, a nozzle and a secondary gas cap is used, wherein the part of the plasma cutting torch from which the plasma jet emerges from the secondary gas cap forms the plasma torch tip, and in which the plasma cutting torch is guided by means of a guidance system along a contour at a cutting speed (v) relative to the workpiece surface in the feed direction in such a manner that at least a small inner contour of the part, the circumference of which is less than or equal to six times the material thickness of the workpiece, or the diameter of which is less than or equal to twice the material thickness of the workpiece, and in such a manner that at least one outer contour and/or a large inner contour of the part, the circumference of which is greater than six times the material thickness of the workpiece, or the diameter of which is greater than twice the material thickness of the workpiece, and the plasma torch tip is at a cutting distance ds from the workpiece surface during cutting, wherein at least a small portion, or the major portion, of the circumference of the small inner contour being cut from the part is cut with a different cutting distance ds between the plasma torch tip and the workpiece surface than at least a small, or a major, portion of the circumference of the outer contour being cut from the part, and/or at least a large portion, or a major portion, of the circumference of the large inner contour being cut from the part.

According to a third aspect, this object is achieved by a method for plasma cutting workpieces, in which a plasma cutting torch which has at least one plasma torch body, an electrode, a nozzle and a secondary gas cap is used, wherein the part of the plasma cutting torch from which the plasma jet emerges from the secondary gas cap forms the plasma torch tip, and in which the plasma cutting torch is guided by means of a guidance system along a contour at a cutting speed v relative to the workpiece surface in the feed direction, and cuts a part from a, in particular plate-shaped, workpiece, wherein the composition and/or the volume flow and/or the mass flow and/or the pressure of a secondary gas SG flowing out of the secondary gas cap, or the cutting distance ds between the plasma torch tip and the workpiece surface is/are changed, at the earliest, when a plasma jet hitting the workpiece surface has reached a position on the contour being cut whose distance from a cut edge yet to be traversed is in a range of a maximum of 50%, more preferably a maximum of 25%, of a material thickness of the workpiece, or whose distance from the cut edge yet to be traversed is in a range of a maximum of 15 mm, more preferably a maximum of 7 mm, or in which the plasma jet hitting the workpiece surface contacts the cut edge.

According to a fourth aspect, this object is achieved by a method for plasma cutting workpieces, in which a plasma cutting torch which has at least one plasma torch body, an electrode, a nozzle and a secondary gas cap is used, wherein the part of the plasma cutting torch from which the plasma jet emerges from the secondary gas cap forms the plasma torch tip, and in which the plasma cutting torch is guided by means of a guidance system along a contour at a cutting speed v relative to the workpiece surface in the feed direction, and cuts a part from a, in particular plate-shaped, workpiece, wherein the composition and/or the volume flow and/or the mass flow and/or the pressure of the secondary gas SG flowing out of the secondary gas cap, and/or the cutting distance ds between the plasma torch tip and the workpiece surface, is changed, at the latest,

when the plasma jet hitting the workpiece surface has reached a position on the contour being cut out
whose distance 502 from the already-traversed cut edge is in a range of a maximum of 25% of the workpiece thickness,
or
whose distance 502 from the cut edge that has already been traversed is in the range of a maximum of 7 mm,
or
in which the plasma jet hitting the workpiece surface has passed the cut edge.

In the method according to the first and the second aspect, it can be provided that the cutting distance ds during the cutting of the small inner contour of the part is less than the cutting distance ds during the cutting of the outer contour of the part and/or the large inner contour of the part.

In particular, it can be provided that the cutting distance ds during the cutting of the small inner contour is between 40% and 80% of the cutting distance ds during the cutting of the outer contour of the part and/or the large inner contour of the part.

According to a further special embodiment, the cutting speed at which the plasma cutting torch is guided relative to the workpiece surface in the feed direction during the cutting of the small inner contour of the part is lower than the cutting speed v during the cutting of the outer contour of the part and/or the large inner contour of the part.

In particular, it can be provided that the cutting speed at which the plasma cutting torch is guided relative to the workpiece surface during the cutting of the small inner contours of the part is between 20% and 80%, preferably between 40% and 80%, of the cutting speed v during the cutting of the outer contour of the part and/or the large inner contour of the part.

Advantageously, the small inner contour/small inner contours are cut first, then the large inner contour/large inner contours are cut, and then the outer contour/outer contours of the part are cut.

In the method according to the third and fourth aspect, it can be provided that the cut edge has been created by cutting the same contour.

Air, oxygen, nitrogen, argon, hydrogen, methane or helium, or a mixture thereof, is advantageously used as the secondary gas.

In particular, it can be provided that the mixture consists of oxygen and/or nitrogen and/or air and/or argon and/or helium, or of argon and/or nitrogen and/or hydrogen and/or methane and/or helium.

According to a particular embodiment, the composition and/or the volume flow and/or the mass flow and/or the pressure of the secondary gas SG flowing out of the secondary gas cap is/are implemented by connecting and/or increasing the volume flow and/or increasing the mass flow and/or increasing the pressure of an oxidizing gas or gas mixture and/or a reducing gas or gas mixture.

In particular, it can be provided that the composition of the secondary gas is changed in such a manner that the increase in the proportion of the oxidizing gas or gas mixture and/or the reducing gas or gas mixture in the secondary gas is at least 10% by volume.

Alternatively, it can be provided that the increase in the volume flow, the mass flow or the pressure of the oxidizing gas or gas mixture and/or the reducing gas or gas mixture in the secondary gas is at least 10%.

The oxidizing gas or gas mixture advantageously contains oxygen and/or air.

In particular, it can be provided that the oxidizing gas is oxygen.

Furthermore, it can be provided that the reducing gas or gas mixture contains hydrogen and/or methane.

In particular, it can be provided that the reducing gas is hydrogen.

According to a particular embodiment, the composition and/or the volume flow and/or the mass flow and/or the pressure of the secondary gas SG flowing out of the secondary gas cap is/are implemented by switching off and/or reducing the volume flow and/or reducing the mass flow and/or reducing the pressure of nitrogen, argon, air, helium or the mixture thereof.

In particular, it can be provided that the composition of the secondary gas is changed in such a way that the reduction in the volume flow, the mass flow or the pressure of the gases or the gas mixture in the secondary gas is at least 10%.

Alternatively, it can be provided that the reduction in the volume flow, the mass flow or the pressure of the gases or the gas mixture in the secondary gas is at least 10%.

The cutting distance ds between the plasma torch tip and the workpiece surface is expediently reduced.

The cutting distance ds is advantageously reduced by at least 25% and/or at least 1 mm.

According to a further special embodiment, it can be provided that the cutting speed v, at which the plasma cutting torch is guided relative to the workpiece surface, is changed, at the earliest, when the plasma jet hitting the workpiece surface has reached a position on the contour being cut whose distance from the cut edge yet to be traversed is in the range of a maximum of 50%, more preferably a maximum of 25%, of the material thickness of the workpiece, or whose distance from the cut edge yet to be traversed is in a range of a maximum of 15 mm, more preferably a maximum of 7 mm, or at which the plasma jet hitting the workpiece surface contacts the cut edge.

Advantageously, the cutting speed v, at which the plasma cutting torch is guided relative to the workpiece surface, is changed, at the latest, when the plasma jet hitting the workpiece surface has reached a position on the contour being cut whose distance from the cut edge that has already been traversed is in the range of a maximum of 25% of the workpiece thickness, or whose distance from the cut edge that has already been traversed is in the range of 7 mm, or at which the plasma jet hitting the workpiece surface has passed the cut edge.

In particular, it can be provided that the cutting speed v is increased.

Finally, it can be provided in particular that the cutting speed v is increased by at least 10%. Based on investigations, the present invention is based on the following knowledge:

If the different types of contours, such as small inner contours, large inner contours and outer contours, are cut with the same parameters, different cut qualities are obtained. In particular, the cut quality of the small inner contours deteriorates—in particular, the perpendicularity and inclination tolerance according to DIN ISO 9013—that is, the cut faces are no longer formed essentially at right angles to the workpiece surface. It was surprisingly found that by changing, in particular reducing, the plasma torch distance (cutting distance) when cutting small inner contours compared to the outer contours or large inner contours, a significant improvement in the quality of the cut is achieved. In particular, the perpendicularity and inclination tolerance improves. A further improvement is achieved if the cutting speed for cutting the small inner contours is also reduced. Since the inner contours are small, this has only a minor effect on the total cutting time. The cutting speed of the small contours can be between 20% and 80%, more preferably between 40% and 80%, of the cutting speed of the outer contours or large inner contours.

Another advantage of using different plasma torch distances (cutting distances), especially for the larger plasma torch distances with large inner and outer contours, is that the cutting process is less susceptible to interference than with small cutting distances. Here, contamination of the workpiece surface, for example from slag splashes that the plasma torch tip could “hit”, is less of a problem. In this way, the high cut quality of the inner contours, and the high productivity, cut quality and process reliability for the outer contours and large inner contours on a workpiece are achieved. It is not necessary to change the wearing parts of the plasma torch. It is also not necessary to change the plasma gas or the secondary gas between the different contours. It is advantageous that it is possible simply to cut with a different plasma torch distance (cutting distance) and/or a different cutting speed, since this change can take place very quickly. For this purpose, only the time for transmission of the electronic signal, for example, <5 ms, is required; a wait time as in, for example, the case of changing wear parts or changing gas, of >0.1 to 5 seconds, is not necessary. The associated gas losses and gas consumption are also reduced.

Different data sets, for example, for cutting one and the same material, that is, for the same material type and thickness for different contours (small inner contours, large inner contours, outer contours) can be stored in the controller of the guidance system or the plasma cutting system, which data sets are then assigned to the given cutting task. It is also possible to set a fixed or variable reduction in the plasma torch distance (cutting distance) and/or the cutting speed for small contours.

Furthermore, in at least one particular embodiment, cutting even-smaller inner contours in better quality is made possible. These are contours whose circumferential length is equal to or less than three times the material thickness (or the diameter of which is less than the material thickness itself). For this, the cutting speed is reduced again in order to achieve a high cut quality in these contours as well. The reduced cutting speed can be between 40% and 80% of the cutting speed of the large contours.

The end of the cut is particularly critical for the quality of an inner contour, and also an outer contour. This is in particular the case when the plasma jet reaches the point where it re-enters the kerf that has already been created by the same cut, and passes over the workpiece edge of this kerf. At this point, the workpiece edge can be “skipped”, the scrap part can “fall out” of the contour, and the plasma jet can be applied to the already existing cut face of the inner contour.

When the kerf is skipped, a disruptive projection usually remains. When the plasma jet is applied to the already existing cut face, “washouts” occur, which also have a negative impact on the quality of the cut. An attempt is made to reduce the projection by reducing the cutting speed. However, this in turn increases the washout.

It is known to change the composition of the secondary gas between the individual cutting processes in order to first cut small holes, and then large contours. Switching takes place during the period in which there is no cutting, and has the disadvantage that it takes time.

In the method according to claim 8, it should be clear that the relevant issue is the composition of the secondary gas when it emerges from the bore of the secondary gas cap or when it hits the plasma jet, and not where the change in composition occurs through valves in or in front of the plasma torch shaft.

Further features and advantages of the invention emerge from the appended claims and from the following description, in which several embodiments of the present invention are described in detail with reference to the schematic drawings, wherein:

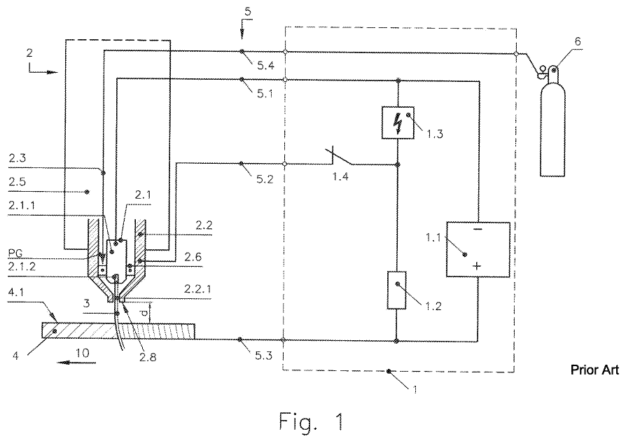

FIG. 1 is a schematic diagram of an arrangement for plasma cutting according to the prior art;

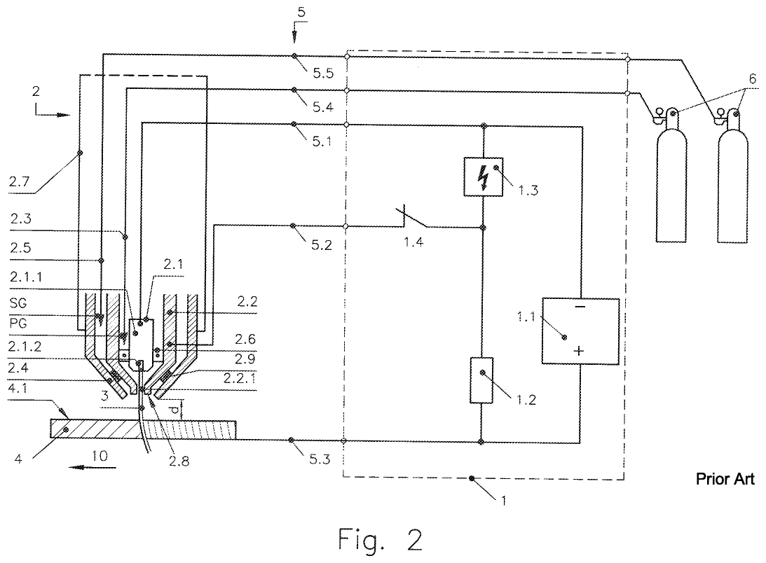

FIG. 2 is a schematic diagram of a further arrangement for plasma cutting according to the prior art;

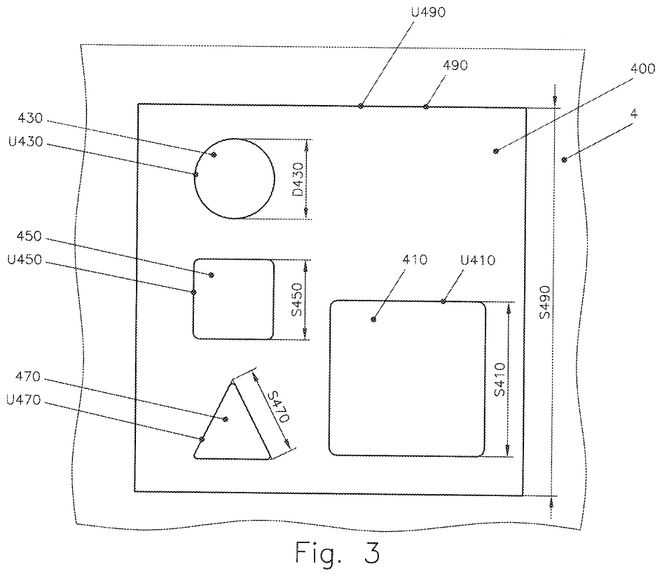

FIG. 3 is a plan view of a part being cut from a workpiece;

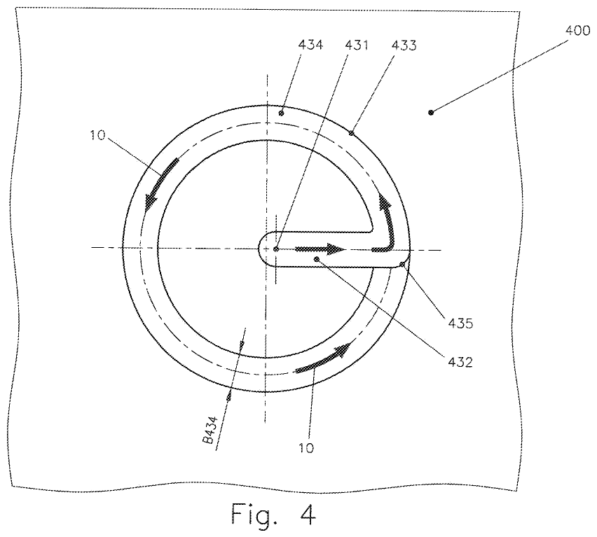

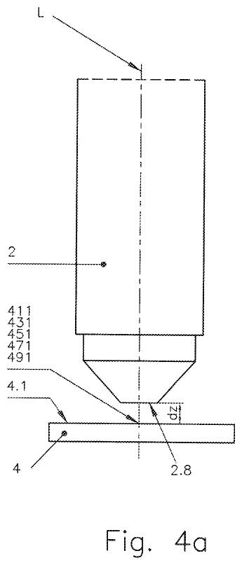

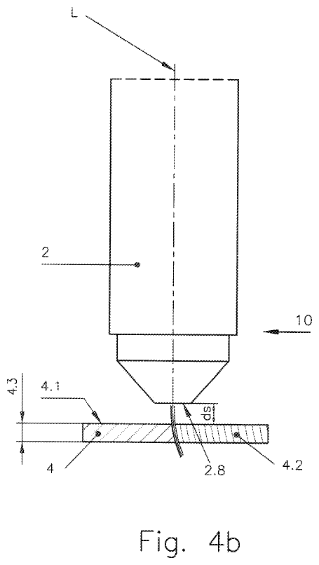

FIG. 4 is a detailed view of FIG. 3, in which cutting paths for cutting out an inner contour are drawn;

FIG. 4a is a side view of a plasma cutting torch above the workpiece shown in FIG. 3, during ignition;

FIG. 4b is a side view similar to that of FIG. 4a, but with the plasma cutting torch being shown at a point in time during cutting after ignition;

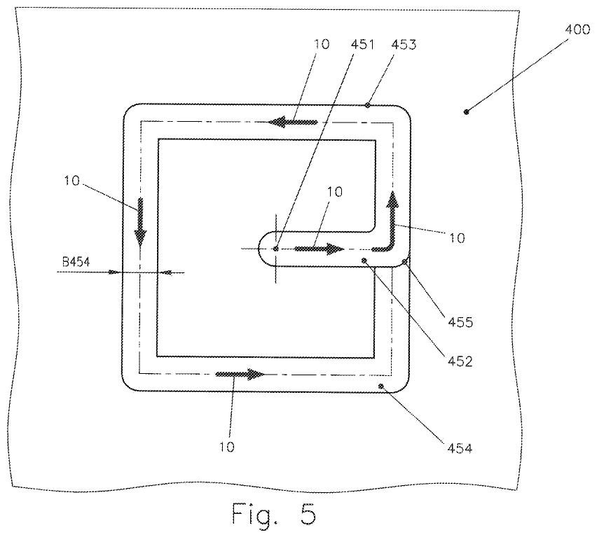

FIG. 5 is a detailed view similar to that of FIG. 3, but in which cutting paths for cutting out a further inner contour are drawn;

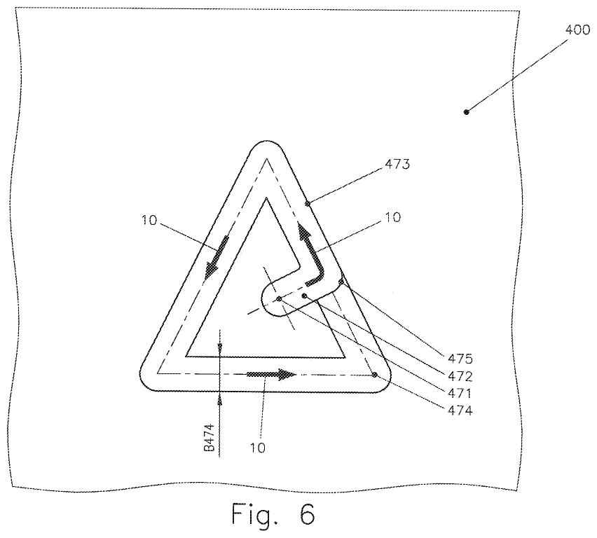

FIG. 6 is a detailed view similar to that of FIG. 3, but in which cutting paths for cutting out a further inner contour are drawn;

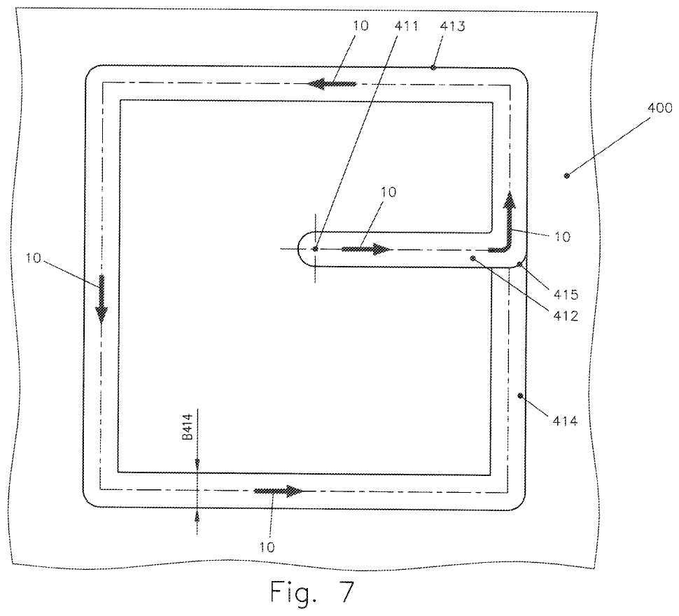

FIG. 7 is a detailed view similar to that of FIG. 3, but in which cutting paths for cutting out a further inner contour are drawn;

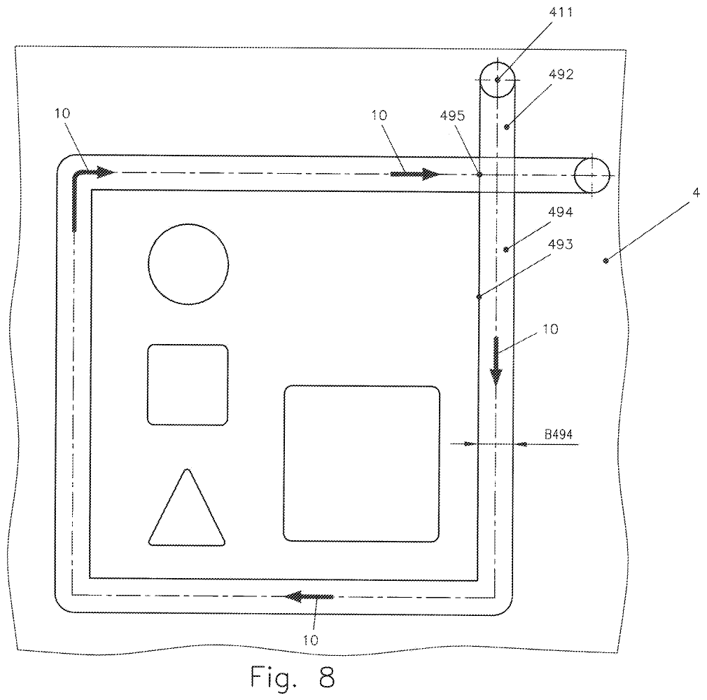

FIG. 8 is a plan view of the part of FIG. 3 after the cutting out of the inner contours shown in FIGS. 5 to 7, in which the cutting paths for cutting out an outer contour are drawn;

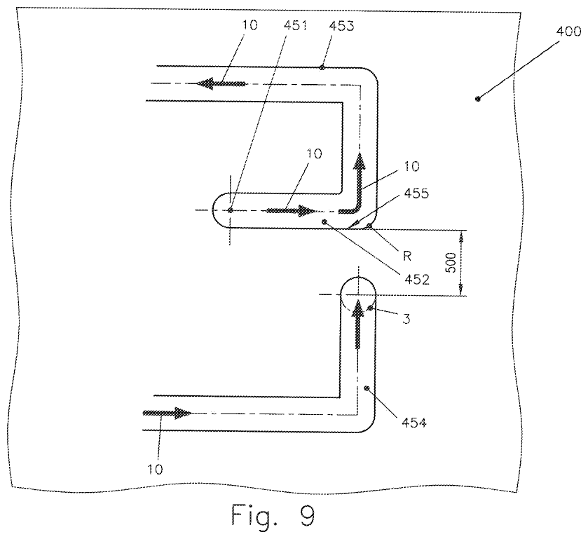

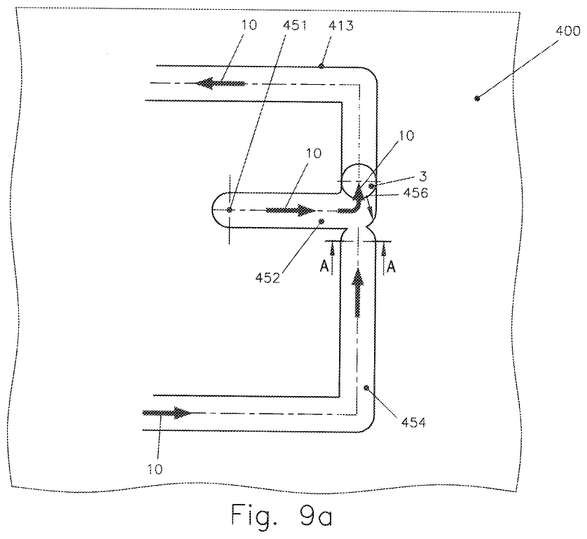

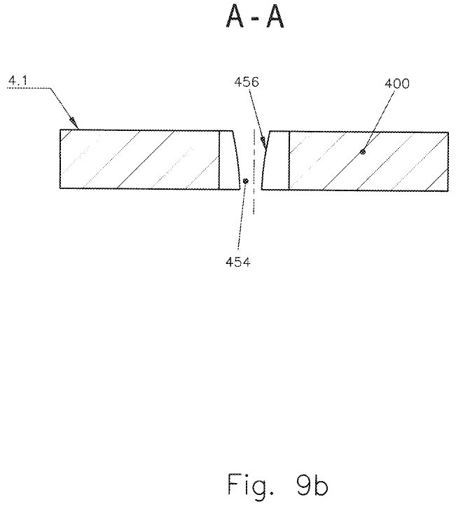

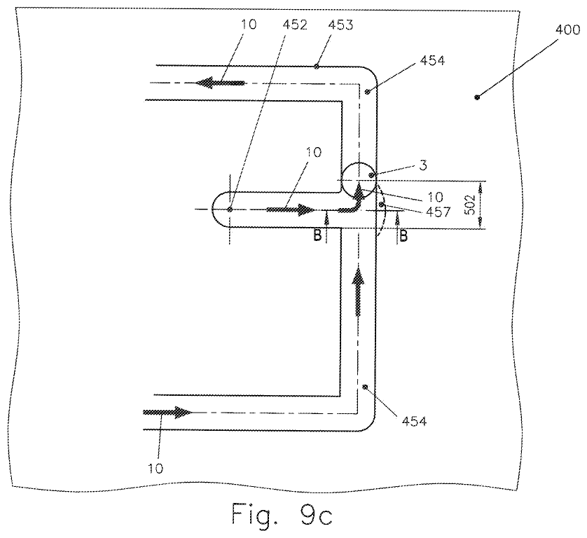

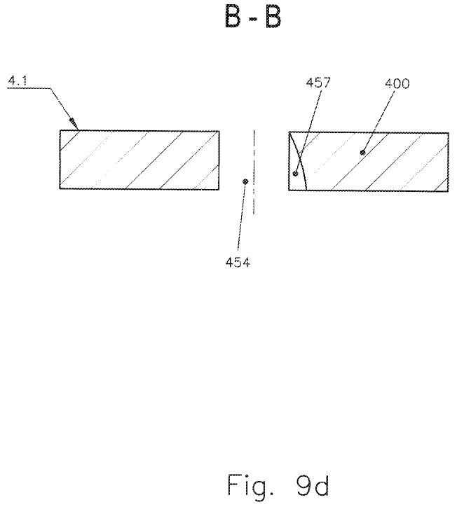

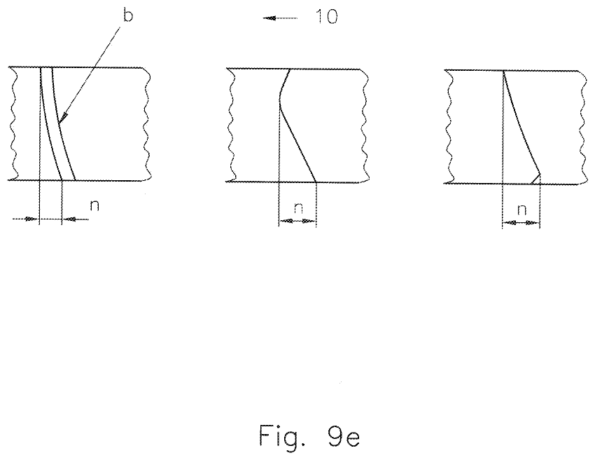

FIG. 9 is a detailed view of FIG. 5 for a more precise illustration of the end of the cutting process of the inner contour;

FIG. 9a is a further detailed view similar to that of FIG. 9, but at a later stage of the end of the cutting process;

FIG. 9b is a sectional view A—A of FIG. 9a;

FIG. 9c is a further detailed view similar to that of FIG. 9a, but at an even later stage of the end of the cutting process;

FIG. 9d is a sectional view B—B of FIG. 9c;

FIG. 9e shows grooves and their wakes caused by the deflection of the plasma jet during the cutting on a cut face of the workpiece;

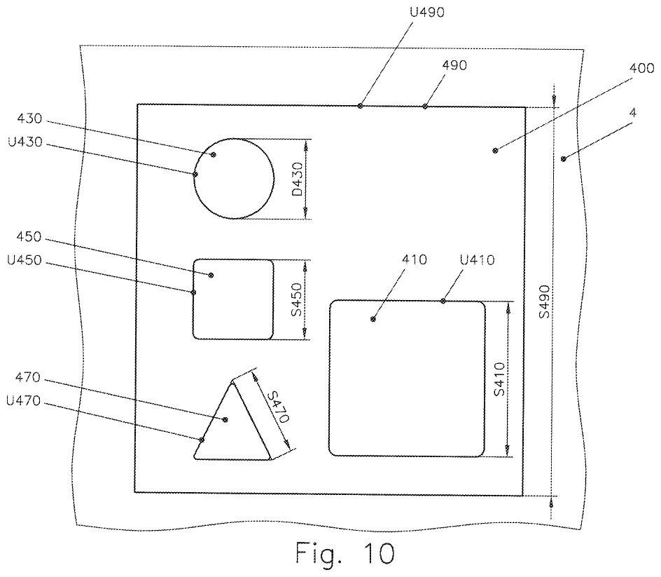

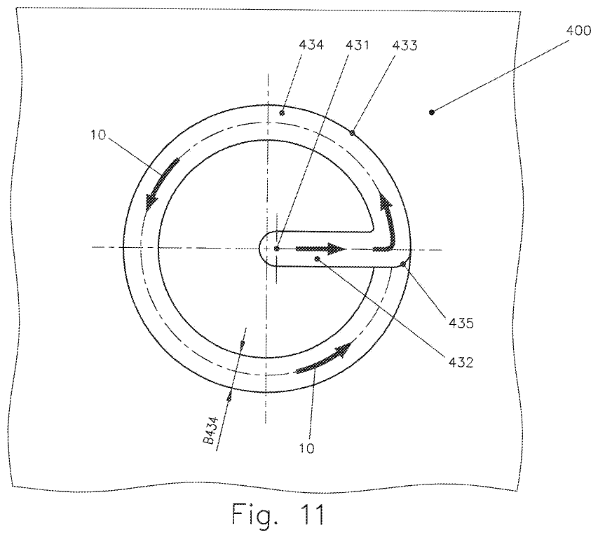

FIG. 10 is a plan view of a part being cut out of a workpiece made of a different material than the workpiece shown in FIG. 3;

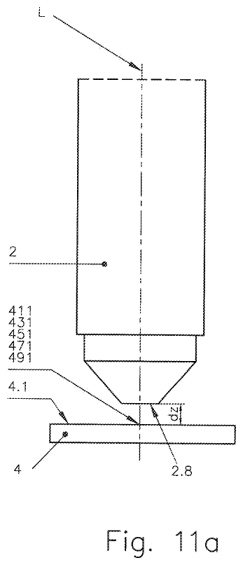

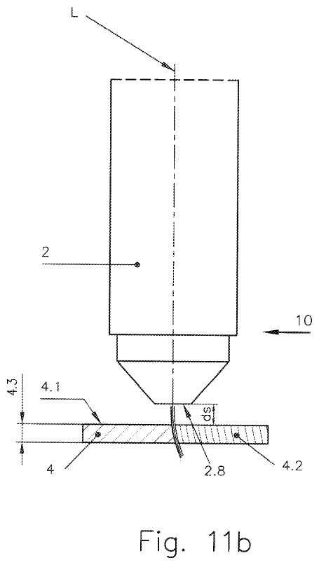

FIG. 11 is a detailed view of FIG. 10, in which cutting paths for cutting out an inner contour are drawn;

FIG. 11a is a side view of a plasma cutting torch above the workpiece shown in FIG. 11 during ignition;

FIG. 11b is a side view similar to that of FIG. 11a, but with the plasma cutting torch being shown at a point in time during cutting after ignition;

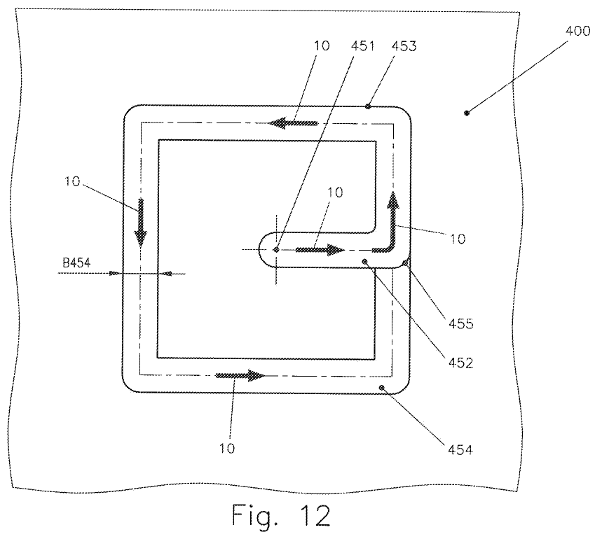

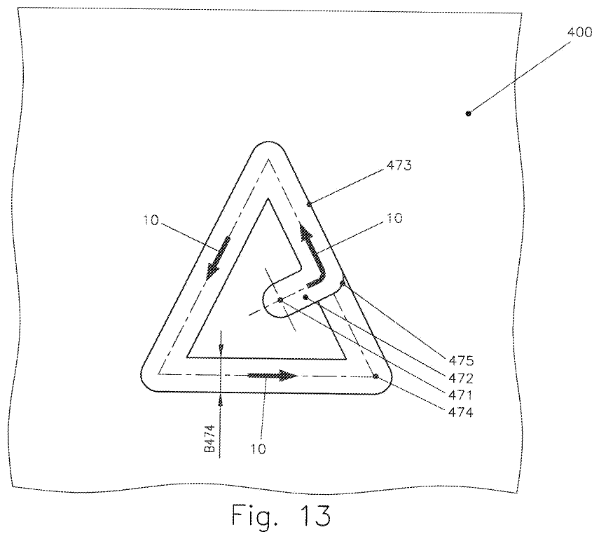

FIG. 12 is a detailed view similar to that of FIG. 10, but in which cutting paths for cutting out a further inner contour are drawn;

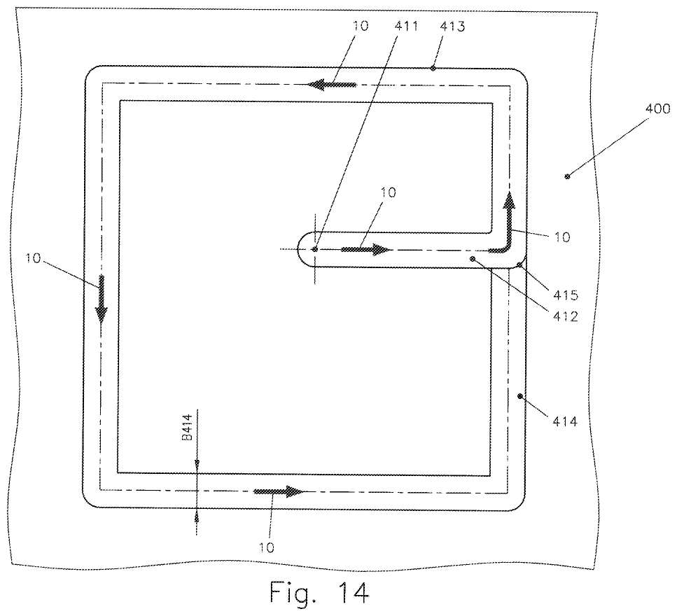

FIG. 13 is a detailed view similar to that of FIG. 10, but in which cutting paths for cutting out a further inner contour are drawn;

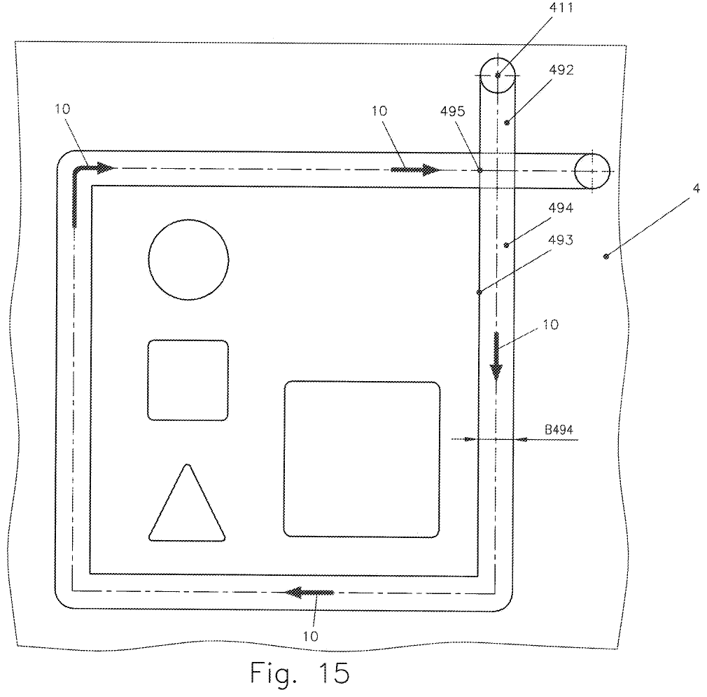

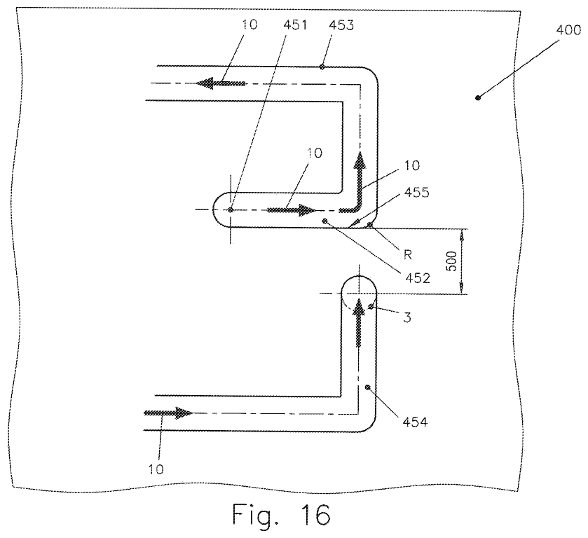

FIG. 14 is a detailed view similar to that of FIG. 10, but in which cutting paths for cutting out a further inner contour are drawn;

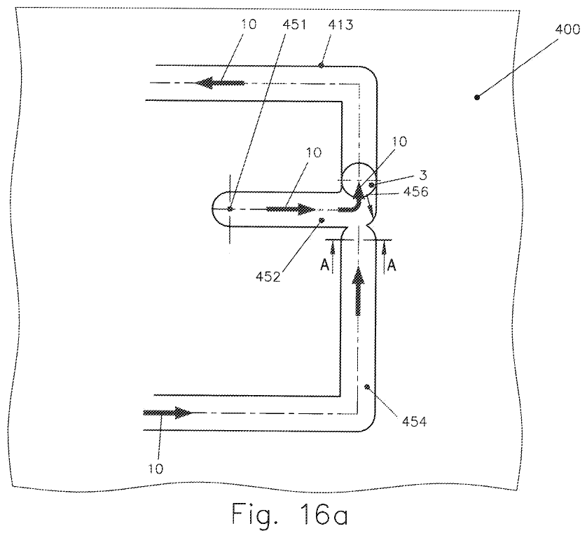

FIG. 15 is a plan view of the part of FIG. 10 after the cutting out of the inner contours shown in FIGS. 12 to 14, in which the cutting paths for cutting out an outer contour are drawn;

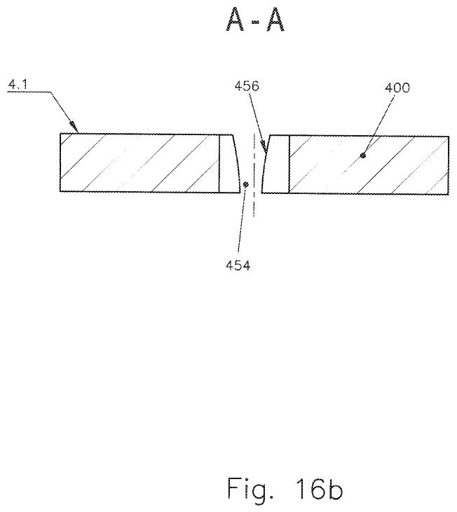

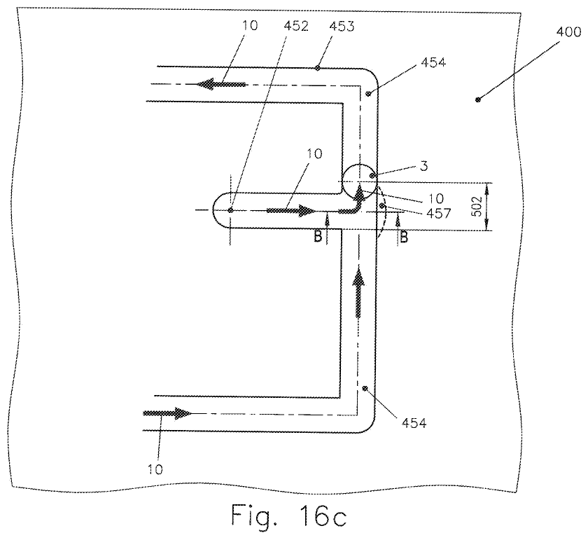

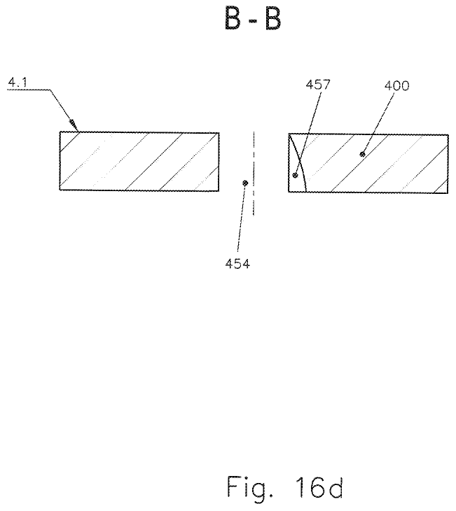

FIG. 16 is a detailed view of FIG. 12 for a more precise illustration of the end of the cutting process of the inner contour;

FIG. 16a is a further detailed view similar to that of FIG. 16, but at a later stage of the end of the cutting process;

FIG. 16b is a sectional view A—A of FIG. 16a;

FIG. 16c is a further detailed view similar to that of FIG. 16a, but at an even later stage of the end of the cutting process;

FIG. 16d is a sectional view B—B of FIG. 16c; and

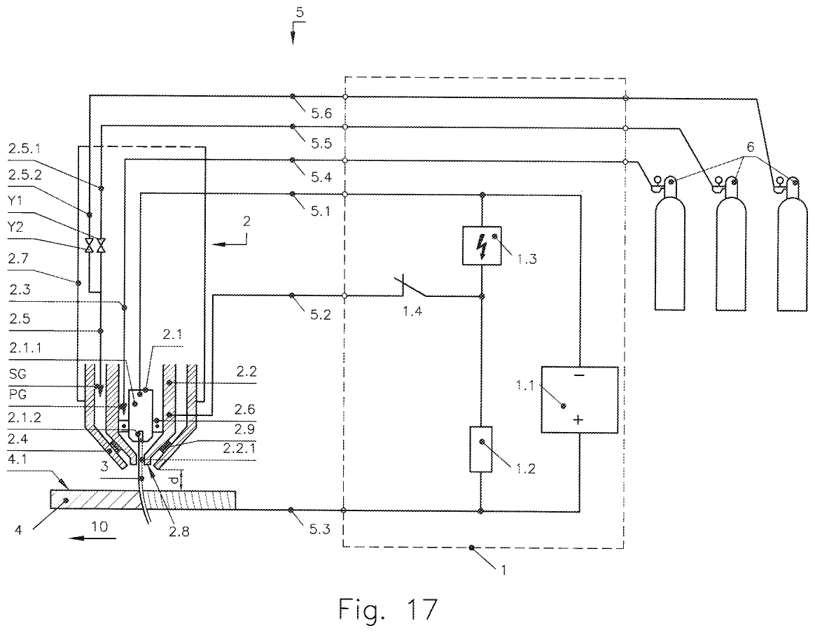

FIG. 17 is a schematic diagram of an arrangement for plasma cutting according to a particular embodiment of the present invention, for performing a method for plasma cutting workpieces according to a particular embodiment of the present invention.

Conventional arrangements for plasma cutting are shown schematically in FIGS. 1 and 2. An electrical cutting current flows from a power source 1.1 of the plasma cutting system 1 via an electrical line 5.1 to a plasma cutting torch 2 via an electrode 2.1 of the plasma cutting torch 2, a plasma jet 3 constricted by a nozzle 2.2 and a nozzle bore 2.2.1 to a workpiece 4, and then via an electrical line 5.3 back to a power source 1.1. The gas supply to the plasma cutting torch 2 takes place via lines 5.4 and 5.5 from a gas supply 6 to the plasma cutting torch 2. A high-voltage ignition device 1.3, a pilot resistor 1.2, the power source 1.1 and a switching contact 1.4 and controller thereof are located in the plasma cutting system 1. Valves for controlling the gases can also be provided. However, these are not shown here.

The plasma cutting torch 2 substantially comprises a plasma torch head with a beam generation system, comprising the electrode 2.1, the nozzle 2.2, a gas supply 2.3 for plasma gas PG, and a plasma torch body 2.7 which supplies the media (gas, cooling water and electrical current) and accommodates the beam generation system. The electrode 2.1 of the plasma cutting torch 2 is a non-consumable electrode 2.1, which consists substantially of a high-temperature material such as tungsten, zirconium or hafnium, and therefore has a very long service life. The electrode 2.1 often consists of two parts connected to one another, an electrode holder 2.1.1, which is made of a material that conducts electricity and heat well (for example, copper, silver, alloys thereof), and a high-melting emission insert 2.1.2 with a low work function for electrons (hafnium, zirconium, tungsten). The nozzle 2.2 is made mostly of copper, and constricts the plasma jet 3. A gas conduit 2.6 for the plasma gas PG, which adds a rotary movement to the plasma gas, can be arranged between the electrode 2.1 and the nozzle 2.2. In this embodiment, the part of the plasma cutting torch 2 from which the plasma jet 3 emerges from the nozzle 2.2 is referred to as the plasma torch tip 2.8. The distance between the plasma torch tip 2.8 and the workpiece surface 4.1 is denoted by d. In this example, this distance corresponds to the distance between the nozzle 2.2 and the workpiece surface 4.1. The same applies to the cutting and ignition portions ds and dz mentioned below.

In FIG. 2, a secondary gas cap 2.4 (protective nozzle cap) for supplying a secondary medium, for example a secondary gas SG, is additionally attached around the nozzle 2.2 of the plasma cutting torch 2. The combination consisting of the secondary gas cap 2.4 and the secondary gas SG protects the nozzle 2.2 from damage when the plasma jet 3 pierces the workpiece 4, and creates a defined atmosphere around the plasma jet 3. Between the nozzle 2.2 and the secondary gas cap 4, there is a gas conduit 2.9 which can add a rotary movement to the secondary gas. In this embodiment, the point of the plasma cutting torch 2 from which the plasma jet 3 emerges from the secondary gas cap 2.4 is referred to as the plasma torch tip 2.8. The distance between the plasma torch tip 2.8 and the workpiece surface 4.1 is also denoted by d. In this example, this distance d corresponds to the distance between the secondary gas cap 2.4 and the workpiece surface 4.1. The same applies to the cutting and ignition distances ds and dz mentioned below.

For the cutting process, a pilot arc is first ignited, which burns between the electrode 2.1 and the nozzle 2.2 with a low electrical current (for example, 10 A-30 A) and thus low power, for example, by means of an electrical high voltage generated by the high voltage ignition device 1.3. The current (pilot current) of the pilot arc flows through the electrical line 5.2 from the nozzle 2.2 via the switching contact 1.4 and the electrical resistor 1.2 to the power source 1.1, and is limited by the pilot resistor (electrical resistor) 1.2. This low-energy pilot arc prepares the path between the plasma cutting torch 2 and the workpiece 4 for the cutting arc by partial ionization. If the pilot arc contacts the workpiece 4, the electrical potential difference generated by the pilot resistor 1.2 between the nozzle 2.2 and the workpiece 4 leads to the formation of the cutting arc. This then burns between the electrode 2.1 and the workpiece 4 with a generally greater electrical current (for example, 20 A to 900 A), and therefore also with greater power. The switch contact 1.4 is opened and the nozzle 2.2 is connected and isolated by the power source 1.1. This mode of operation is also referred to as the direct mode of operation. The workpiece 4 is exposed to the thermal, kinetic and electrical action of the plasma jet 3. This makes the process very effective, and it is possible to cut metals up to great thicknesses, for example 180 mm at 600 A cutting current, at a cutting speed of 0.2 m/min.

For this purpose, the plasma cutting torch 2 is moved with a guidance system relative to a workpiece 4 or its surface 4.1. This can, for example, be a robot or a CNC-controlled guide machine. The controller of the guidance system (not shown) communicates with the arrangement according to FIG. 1 or 2.

In the simplest case, it starts and ends the operation of the plasma cutting torch 2. According to the current state of the art, however, a variety of signals and information—for example, about operating conditions—and data can be exchanged.

With plasma cutting, high cutting qualities can be achieved. The criteria for measuring this quality are, for example, tight perpendicularity tolerances and inclination tolerances according to DIN ISO 9013. If the optimal cutting parameters are adhered to, including the electrical cutting current, the cutting speed, the distance between the plasma cutting torch and the workpiece, and the gas pressure, smooth cut faces and burr-free edges can be achieved.

For the quality of the cut, it is also important that the electrode 2.1, in particular its emission insert 2.1.2, and the nozzle 2.2, in particular its nozzle bore 2.2.1, and, if present, the secondary gas cap 2.4, and in particular its bore, lie on a common axis, in order to obtain the same or at least only slightly different perpendicularity and inclination tolerances at the different cut edges in every direction of movement of the plasma cutting torch 2 relative to the workpiece.

In plasma cutting, perpendicularity and inclination tolerances of quality 2 to 4 according to DIN ISO 9013 are state of the art. This corresponds to an angle of up to 3°.

FIG. 3 shows, by way of example, a top view of a part 400 which is being cut out of a workpiece 4. The part 400 being cut out has, for example, four inner contours 410, 430, 450 and 470 and, for example, an outer contour 490. In this example, the workpiece is made of structural steel, that is to say of unalloyed or low-alloy steel, for example, S235 or S355 according to DIN EN 10 027-1. The material thickness 4.3 of the workpiece 4 is, for example, 10 mm in this case. Oxygen is used, for example, as the plasma gas, and air is used, for example, as the secondary gas. It is also possible, for example, to use a mixture of air and oxygen as the secondary gas. In certain material thickness ranges this leads to smoother, more vertical cut edges.

The inner contour 410 is, for example, a large inner contour, while the inner contours 430, 450 and 470 are, for example, small inner contours. Inner contours are small inner contours if the circumference of the contour is equal to or less than six times the thickness of the workpiece. In this case this is a length of 60 mm, since the workpiece thickness is 10 mm.

The circular inner contour 430 has a diameter D430 of, for example, 10 mm, and the circumference U430 is, for example, approx. 31 mm. The square inner contour 450 has, for example, a side length S450 of 10 mm each, and thus a circumference U430 of 40 mm. The inner contour 470 is, for example, an equilateral triangle and has, for example, a side length S470 of 10 mm each, and thus a circumference U470 of 30 mm.

The inner contour 410 is square in this example, and has a side length S410 of 50 mm each, for example, and thus a circumference U410 of 200 mm.

The outer contour is, for example, a square with a side length S490 of, for example, 100 mm and a circumference U490 of 400 mm. A plurality of parts 400, and also a very wide variety of other parts, can be cut out of the workpiece 4.

In this example, first the small inner contours 430, 450, 470 of a part 400, then the large inner contour 410, and finally the outer contour 490 are cut out. This is shown by way of example in FIGS. 4, 4a and 4b for the inner contour 430, in FIG. 5 for the inner contour 450, in FIG. 6 for the inner contour 470, in FIG. 7 for the inner contour 410 and in FIG. 8 for the outer contour 490.

As shown in FIG. 4a, the plasma torch tip 2.8 of the plasma cutting torch 2 is positioned at a starting point 411 or 431 or 451 or 471 with a defined distance, the ignition distance dz, here for example 4 mm, above the workpiece surface 4.1. The cutting process is started by an ON signal from the guidance system to the plasma cutting system 1, and the cutting arc or plasma jet 3 is initiated as described under FIGS. 1 and 2. With the ignition distance dz, the workpiece 4 being cut is pierced by the plasma jet 3 (insertion), and after a defined time is positioned at a different distance, as shown by way of example in FIG. 4b, over the workpiece surface 4.1, the cutting distance ds, and the cutting is performed at the cutting speed v relative to the workpiece surface 4.1 in the feed direction 10. The cutting distance ds is less than the ignition distance dz. As shown in FIGS. 4, 5, 6 and 7, a kerf 414 or 434 or 454 or 474 is created. The insertion takes place on a scrap part, and the plasma cutting torch 2 is guided over a short section, the so-called insertion tail 412 or 432 or 452 or 472 or 492, that is, the kerf on the scrap part, to the contour that is ultimately being cut out. The plasma jet 3 has, depending on its flow and the diameter of the nozzle bore 2.2.1 through which it emerges, a diameter that corresponds to a certain gap B414 or B434 or B454 or B474 and B494 of the kerfs 414 or 434 or 454 or 474 and 494. For this reason, the plasma cutting torch 2 is guided during cutting at a distance running parallel to the workpiece surface 4.1, between the longitudinal axis L running through the center of the nozzle bore 2.2.1 of the nozzle 2.2 and the desired contour, the so-called kerf offset or kerf compensation. As a rule, the cutting distance ds with which the best cut quality can ultimately be achieved is reached, at the latest, when the contour 410, 430, 450, 470, 490 being cut is reached. The contour has substantially been cut by traversing the cut edge 415 or 435 or 455 or 475 or 495 which was formed by the kerf of the insertion tail 412 or 432 or 452 or 472 or 492. The contour is ultimately formed by the cut edges 413, 433, 453, 473, 493.

The small inner contours 430, 450 and 470 are cut in this case, by way of example, with a current of 100 A, a cutting distance ds of, for example, 1.5 mm, and a cutting speed v of, for example, 1.4 m/min. The large inner contour 410 and the outer contour 490 are cut, for example, with a current of 100 A, a cutting distance of ds=3 mm, and a cutting speed v of 2.5 m/min. The small inner contours 430, 450 and 470 are cut in this case at a smaller cutting distance ds and a lower cutting speed v than the large inner contour 410 and the outer contour 490. The direction of travel (feed direction 10) of the small and large inner contours is the same in this example; the direction of travel of the outer contour 490 is opposite in this example, as can also be seen from FIGS. 4 to 8.

FIG. 9 and the following show the view of the workpiece 4 from above. The end of the cutting process of the inner contour 450 can be seen more precisely. The following descriptions also apply to the other inner contours 410, 430 and 470 and to the outer contour 490. The plasma jet 3 of the plasma cutting torch 2 has cut part of the kerf 454, and will immediately pass over the cut edge 455 which is formed by the kerf of the insertion tail 452. The plasma jet 3 usually runs in the opposite direction to its feed direction 10, as shown in FIG. 4b. That is to say, it is deflected. A slight deflection of the plasma jet leads to low-burr or burr-free cuts, and at the same time to high productivity. In FIG. 9e, the grooves b which arise during the cutting on the cut face 4.2 and which follow due to the deflection of the plasma jet, are shown. The greatest distance between two points of a cutting groove in the cutting direction is called groove lag n according to DIN ISO 9013.

The problem that can occur when cutting at the end of an inner contour, namely a protrusion 456 that arises or remains when the cut edge 455 is traversed, as shown in FIG. 9a, has already been described. This is caused by the sudden loss of the material being cut in the feed direction 10 when the cut edge 455 of the insertion tail 452 is passed over. The plasma jet 3 jumps, so to speak, in the feed direction 10 along the cut edge of the kerf, and the drag suddenly decreases. This creates the protrusion 456, which is usually more pronounced on the underside of the workpiece 4, that is, on the exit side of the plasma jet 3 from the workpiece 4, than on the workpiece surface 4.1 where the plasma jet 3 enters the workpiece. This can be seen in FIG. 9b in section A-A through the kerf 454 in the region of the protrusion 456.

Attempts are made to counteract this effect by reducing the feed rate v. However, this leads to washouts 457 in the cut edge or cut face that is already present, particularly in the direction of the lower surface of the workpiece 4, as shown in FIG. 9c. FIG. 9d shows the section B—B through the kerf 454 in the region of the washout 457.

The same problem also arises during the cutting of the outer contour 490 when the cut edge 495 formed by the insertion tail 492 is traversed.

As already described under FIG. 3, structural steel is cut in this case, by way of example. Oxygen is used as the plasma gas, and air as the secondary gas. By adding oxygen to the air of the secondary gas when the plasma jet 3 passes over the cut edge 455, the formation of the protrusion 456 is reduced. Since the cutting speed v does not have to be reduced, the formation of the washout 457 is also reduced or even prevented. The cut face has been further improved in cases where the oxygen content in the secondary gas at the outlet of the secondary gas cap, and the cutting speed, are increased. The cutting speed v should preferably only be increased if the oxygen content of the secondary gas emerging from the secondary gas cap is increased. The increase in the proportion of oxygen should preferably be at least 10% of the volume flow or 10% by volume of the total secondary gas during the majority of the time the contour is cut. This can be achieved, for example, by increasing the pressure and/or the volume and/or mass flow of the oxygen in the secondary gas. There is also the possibility of reducing the proportion of the other gas, for example air or nitrogen, for example by reducing the pressure and/or the volume and/or mass flow thereof, and thus increasing the oxygen proportion. After the cut edge 455 has been traversed and the already cut kerf 454 has been reached after passing at least part of, or the entire, insertion tail, the cutting current is initially reduced, and ultimately switched off.

FIG. 9 shows, by way of example, the distance 500 before and/or from the cut edge 455 that is yet to be traversed, at which distance the composition, the volume flow and/or the pressure of the secondary gas flowing out of the secondary gas cap 2.4, and/or the cutting distance ds between the plasma torch tip and the workpiece surface can be changed. In this case, it is, for example, 10 mm, and thus corresponds to the workpiece thickness in this example.

FIG. 9c shows, by way of example, the distance 502 after and/or from the already traversed cut edge 455 at which the composition, the volume flow and/or the pressure of the secondary gas flowing out of the secondary gas cap, and/or the distance between the plasma torch tip and the workpiece surface can be changed. It is 7 mm in this case, by way of example.

It is also possible to use nitrogen as the secondary gas. In this case as well, oxygen is added to the secondary gas, and thus the proportion of oxygen is increased in the conditions noted above.

The oxygen content in the secondary gas can also be up to 100%, preferably a maximum of 80% of the volume flow or mass flow.

When cutting high-alloy steels, for example, 1.4301 (X5CrNi10-10) or 1.4541 (X6CrNiTi18-10), the plasma gas used can be nitrogen, argon, an argon-hydrogen mixture, a nitrogen-hydrogen mixture or an argon-hydrogen-nitrogen mixture. The secondary gas used is also most commonly nitrogen, argon, an argon-hydrogen mixture, a nitrogen-hydrogen mixture or an argon-hydrogen-nitrogen mixture.

FIG. 10 shows, by way of example, the plan view of a part 400 that is being cut out of a workpiece 4. The part 400 being cut out has four inner contours 410, 430, 450 and 470, as well as one outer contour 490. The workpiece is made of structural steel, that is, unalloyed or low-alloy steel, for example, 1.4301 (X5CrNi10-10) or 1.4541 (X6CrNiTi18-10) 1. The thickness of the workpiece 4 is 10 mm, for example. An argon-hydrogen mixture is used as the plasma gas, for example, and nitrogen is used as the secondary gas. There is also the option of using a mixture of nitrogen and hydrogen as the secondary gas. In certain material thickness ranges this leads to smoother, more vertical cut edges.

The inner contour 410 in this example is a large inner contour. The inner contours 430, 450 and 470 are small inner contours, for example. Inner contours are small inner contours if the circumference of the contour is equal to or less than six times the thickness 4.3 of the workpiece 4. In this case this is a length of 60 mm, since the workpiece thickness is 10 mm.

The circular inner contour 430 has a diameter D430 of 15 mm, for example. The circumference of U430 is approximately 47 mm, for example. The inner contour 450 is, for example, square and has a side length S450 of, for example, 14 mm each, and thus a circumference U430 of 56 mm. The inner contour 470 is, for example, an equilateral triangle and has a side length S470 of 15 mm each, for example, and thus a circumference U470 of 45 mm.

The inner contour 410 is square, for example, and has a side length S410 of 50 mm each, for example, and thus a circumference U410 of 200 mm.

In this example, the outer contour 490 is a square with a side length S490 of, for example, 100 mm and thus has a circumference of 400 mm. A plurality of parts 400, and also a very wide variety of other parts, can be cut out of the workpiece 4.

In this example, first the inner contours 430, 450, 470 of a part 400, then the large inner contour 410, and finally the outer contour 490 are cut out. This is shown by way of example in FIGS. 11, 11a and 11b for the inner contour 430, in FIG. 12 for the inner contour 450, in FIG. 13 for the inner contour 470, in FIG. 14 for the inner contour 410 and in FIG. 15 for the outer contour 490.

As shown in FIG. 11a, the plasma torch tip 2.8 of the plasma cutting torch 2 is positioned at a starting point 411 or 431 or 451 or 471 or 491 with a defined distance, the ignition distance dz, here for example 5 mm, above the workpiece surface 4.1. The cutting process is started by an ON signal from the guidance system to the plasma cutting system 1, and the cutting arc or plasma jet 3 is initiated as described under FIGS. 1 and 2. With the ignition distance dz, the workpiece 4 being cut is pierced by the plasma jet 3 (insertion), and after a defined time is positioned at a different distance above the workpiece 4.1, as shown in FIG. 11b, the cutting distance ds, and the cutting is performed in the feed direction 10 at the cutting speed v relative to the workpiece surface 4.1. The cutting distance ds is less than the ignition distance dz. As shown in FIGS. 11, 12, 13 and 14, the kerf 414 or 434 or 454 or 474 or 494 is created. The insertion takes place on a scrap part, and the plasma cutting torch 2 is guided over a short section, the so-called insertion tail 412 or 432 or 452 or 472 or 492, that is, the kerf on the scrap part, to the contour that is ultimately being cut out. The plasma jet 3 has, depending on its flow and diameter of the nozzle bore 2.2.1 through which it emerges, a diameter that corresponds to a certain gap B414 or B434 or B454 or B474 or B494 of the kerfs 414 or 434 or 454, 474, and 494, respectively. For this reason, the plasma cutting torch 2 is guided during cutting at a distance running parallel to the workpiece surface 4.1, between the longitudinal axis L running through the center of the nozzle bore 2.2.1 of the nozzle 2.2 and the desired contour, the so-called kerf offset or kerf compensation. As a rule, the cutting distance ds at which the best cut quality can ultimately be achieved is reached at the latest when the contour 410 or 430 or 450 or 470 or 490 being cut is reached. The contour has substantially been cut by traversing the cut edge 415 or 435 or 455 or 475 or 495 which was formed by the kerf of the insertion tail 412 or 432 or 452 or 472 or 492. The contour is ultimately formed by the cut edges 413 or 433 or 453 or 473 or 493.

The small inner contours 430, 450 and 470 are cut in this case, by way of example, with a current of 130 A, a cutting distance ds of, for example, 2.0 mm and a cutting speed v of, for example, 1.0 m/min. The large inner contour 410 and the outer contour 490 are cut with a current of, for example, 130 A, a cutting distance of, for example, ds=3 mm and a cutting speed v of, for example, 1.4 m/min. The small inner contours 430, 450 and 470 are cut in this case at a smaller cutting distance ds and a lower cutting speed v than the large inner contour 410 and the outer contour 490.

The direction of travel (feed direction 10) of the small and large inner contours is the same in this example. The direction of travel around the outer contour 490 is opposite in this example, as can also be seen from FIGS. 11 to 15.

FIG. 16 and the following show the view of the workpiece 4 from above. The end of the cutting process of the inner contour 450 can be seen more precisely. The following descriptions also apply to the other inner contours 410, 430 and 470. The plasma jet 3 of the plasma cutting torch 2 has cut part of the kerf 454, and will immediately pass over the cut edge 455 which is formed by the kerf of the insertion tail 452. The plasma jet 3 usually runs in the opposite direction to its feed direction 10, as shown in FIG. 9, so it is deflected. A slight deflection of the plasma jet leads to low-burr or burr-free cuts, and at the same time to high productivity. FIG. 9a shows the grooves b which arise during the cutting on the cut face 4.2 and which follow due to the deflection of the plasma jet. The greatest distance between two points of a cutting groove in the cutting direction is called groove lag n according to DIN ISO 9013.

The problem that can occur when cutting at the end of an inner contour, namely a protrusion 456 that arises or remains when the cut edge 455 is traversed, as shown in FIG. 16a, has already been described. This is caused by the sudden loss of the material being cut in the feed direction 10 when the cut edge 455 of the insertion tail 452 is passed over. The plasma jet 3 jumps, so to speak, in the feed direction 10 along the cut edge of the kerf, and the drag suddenly decreases. This creates the protrusion 456, which is usually more pronounced on the underside of the workpiece 4, that is, on the exit side of the plasma jet 3 from the workpiece 4, than on the workpiece surface 4.1 where the plasma jet 3 enters the workpiece. This can be seen in FIG. 16b in section A-A through the kerf 454 in the region of the protrusion 456.

An attempt is made to counteract this effect by reducing the feed speed v, but this leads to washouts 457 in the already existing cut edge or cut face, particularly in the direction of the lower surface of the workpiece 4, as shown in FIG. 15c. FIG. 16d shows the section B—B through the kerf 454 in the region of the washout 457.

As already described under FIG. 10, high-alloy steel is cut here by way of example, an argon-hydrogen mixture is used as the plasma gas, and nitrogen is used as the secondary gas. By adding hydrogen to the nitrogen of the secondary gas, when the plasma jet 3 passes over the cut edge 455, the formation of the protrusion 456 is reduced. Since the cutting speed does not have to be reduced, the formation of the washout 457 is also reduced or even prevented. The cut face would be further improved if the hydrogen content in the secondary gas at the outlet of the secondary gas cap and the cutting speed are increased. The cutting speed should preferably only be increased when the hydrogen content of the secondary gas emerging from the secondary gas cap is increased. The increase in the hydrogen content should preferably be at least 10% of the volume flow, or 10% by volume of the total secondary gas during the majority of the time the contour is cut. This can be achieved, for example, by increasing the pressure and/or the volume and/or mass flow, or also by switching on the hydrogen in the secondary gas. There is also the possibility of reducing the proportion of the other gas, for example nitrogen, for example by reducing the pressure and/or the volume and/or mass flow, or also switching off, and thus increasing the hydrogen proportion. After the cut edge 455 has been traversed and the already cut kerf 454 has been reached after passing at least part of, or the entire, insertion tail, the cutting current is initially reduced, and ultimately switched off.

FIG. 16 shows, by way of example, the distance 500 before and/or from the cut edge 455 that is yet to be traversed, at which distance the composition, the volume flow and/or the pressure of the secondary gas flowing out of the secondary gas cap 2.4, and/or the cutting distance ds between the plasma torch tip and the workpiece surface can be changed. In this case, it is, for example, 10 mm, and thus corresponds to the workpiece thickness in this example.

In FIG. 16c shows, by way of example, the distance 502 after and/or from the already traversed cut edge 455 at which the composition, the volume flow and/or the pressure of the secondary gas flowing out of the secondary gas cap, and/or the distance between the plasma torch tip and the workpiece surface can be changed. It is 7 mm in this case, by way of example.

FIG. 17 shows an arrangement in accordance with a particular embodiment of the present invention, with which a method in accordance with a particular embodiment of the present invention can be implemented, and which is substantially based on FIGS. 1 and 2. However, a first and a second secondary gas SG1 and SG2 are fed to the plasma torch 2 via the lines 5.5 and 5.6. Solenoid valves Y1 and Y2 are located in the plasma torch body 2.7, and switch the secondary gases SG1 and SG2. The secondary gas 1, for example nitrogen or air, is fed to the plasma jet 3 during cutting by the opening of the solenoid valve Y1. When the cut edge 415 or 435 or 455 or 475 or 495 formed by the insertion tail 412 or 432 or 352 or 472 or 492 is traversed, either the solenoid valve Y2 for the secondary gas SG2, for example oxygen, is opened and mixed with the secondary gas 1. It is also possible to switch off the secondary gas 1 by switching off the solenoid valve Y1, and to allow only the secondary gas 2, for example oxygen, to flow to the plasma jet as the secondary gas.

The point in time of the change in the secondary gas composition is stored in the controller of the guidance system as a function of the profile of the contour being cut, and is emitted as a signal to the plasma cutting system, which then switches the valves.

The different compositions of the secondary gases for the cutting and for the end of the cut when the kerf formed by the insertion tail is traversed are stored in a database.

In some cases it has been shown that the described effects of the remaining protrusion 546 or the washout 457 are reduced if the cutting distance ds of the plasma torch tip 2.8 from the workpiece surface 4.1 in the vicinity of the cut edge 415 or 435 or 455 or 475 or 495 is decreased. By reducing the distance by, for example, 1 mm, the protrusion was reduced.

The point in time when the cutting distance ds is changed is stored in the controller of the guidance system as a function of the profile of the contour being cut, and is emitted to the distance control of the guide machine and/or the plasma cutting torch.

In this case as well, the values for the cutting distance ds for the cutting and for the end of the cut when the kerf formed by the insertion tail is traversed are stored in a database.

The features of the invention disclosed in the above description, in the drawings and in the claims can be essential both individually and in any combination for the implementation of the invention in its various embodiments.

### LIST OF REFERENCE SYMBOLS

1 plasma cutting machine
1.1 power source
1.2 pilot resistor
1.3 high voltage ignitor
1.4 switch contact
2 plasma cutting torch
2.1 electrode
2.1.1 electrode holder
2.1.2 emission insert
2.2 jet
2.2.1 nozzle bore
2.3 gas supply, plasma gas
2.4 secondary gas cap
2.5 secondary gas supply, secondary gas
2.5.1 secondary gas supply, secondary gas 1
2.5.2 secondary gas supply, secondary gas 2
2.6 gas conduit for plasma gas
2.7 plasma torch body
2.8 plasma torch tip
2.9 gas conduit for secondary gas
3 plasma jet
4 workpiece
4.1 workpiece surface
4.2 cut face
4.3 material thickness
5 supply lines
5.1 electrical line, cutting current
5.2 electrical line, pilot current
5.3 electrical line, workpiece—plasma cutting system
5.4 plasma gas line
5.5 secondary gas line 1
5.6 secondary gas line 2
6 gas supply
10 feed direction of the plasma cutting torch
400 part being cut out
410 large inner contour
411 starting point, insertion point
412 insertion tail
413 cut edge
414 kerf
415 cut edge of the insertion tail
430 small inner contour
431 starting point, insertion point
432 insertion tail
433 cut edge
434 kerf
435 cut edge of the insertion tail
450 small inner contour
451 starting point, insertion point
452 insertion tail
453 cut edge
454 kerf
455 cut edge of the insertion tail
456 protrusion
457 washouts
470 small inner contour
471 starting point, insertion point
472 insertion tail
473 cut edge
474 kerf
475 cut edge of the insertion tail
490 outer contour
492 insertion tail
493 cut edge
495 cut edge of the insertion tail
500 distance from the cut edge to be traversed
502 distance from the cut edge that has already been traversed
b groove
B414 gap
B434 gap
B454 gap
B474 gap
B494 gap
D430 small inner contour diameter
d distance between plasma torch tip and workpiece surface
ds cutting distance between plasma torch tip and workpiece surface
dz ignition distance, plasma torch tip to workpiece surface
L longitudinal axis
n groove lag
PG plasma gas
SG secondary gas
SG1 secondary gas 1
SG2 secondary gas 2
S410 side length, large inner contour
S450 side length, small inner contour
S470 side length, small inner contour
S490 side length, outer contour
U410 circumference, large inner contour
U440 circumference, small inner contour
U450 circumference, small inner contour
U470 circumference, small inner contour
U490 perimeter, outer contour
v cutting speed
Y1 secondary gas solenoid valve 1
Y2 secondary gas solenoid valve 2

1. A method for plasma cutting workpieces:
in which a plasma cutting torch which has at least one plasma torch body, an electrode, and a nozzle is used for cutting a part from a workpiece which has a material thickness, wherein the part of the plasma cutting torch from which a plasma jet emerges from the nozzle forms the plasma torch tip;
in which the plasma cutting torch is guided by means of a guidance system along a contour at a cutting speed v relative to the workpiece surface in the feed direction in such a manner that at least a small inner contour of the part, the circumference of which is less than or equal to six times the material thickness of the workpiece, or the diameter of which is less than or equal to twice the material thickness of the workpiece, is/are cut out;
in such a manner that at least one outer contour of the part is cut out;
wherein the plasma torch tip is at a cutting distance ds to the workpiece surface during the cutting; and
wherein a portion of the circumference of the small inner contour being cut from the part is cut at a different cutting distance ds between the plasma torch tip and the workpiece surface than a portion of the circumference of the outer contour being cut from the part.

2-28. (canceled)

29. The method of claim 1 wherein a large inner contour of the part, the circumference of which is greater than six times the material thickness of the workpiece, or the diameter of which is greater than twice the material thickness of the workpiece, is/are cut out.

30. The method of claim 1 further comprising at least one portion of the circumference of the large inner contour being cut from the part.

31. A method for plasma cutting workpieces:
in which a plasma cutting torch which has least one plasma torch body, an electrode, a nozzle and a secondary gas cap is used, wherein the part of the plasma cutting torch out of which the plasma jet emerges from the secondary gas cap forms the plasma torch tip;
in which the plasma cutting torch is guided by means of a guidance system along a contour at a cutting speed (v) relative to the workpiece surface in the feed direction in such a manner that at least a small inner contour of the part, the circumference of which is less than or equal to six times the material thickness of the workpiece, or the diameter of which is less than or equal to twice the material thickness of the workpiece, is/are cut out;
in such a manner that at least one outer contour or an inner contour of the part, the circumference of which is greater than six times the material thickness of the workpiece, or the diameter of which is greater than twice the material thickness of the workpiece, is/are cut out and the plasma torch tip is at a cutting distance ds from the workpiece surface during the cutting;
wherein at least a small portion, or the major portion, of the circumference of the small inner contour being cut from the part is cut at a different cutting distance ds between the plasma torch tip and the workpiece surface than at least a portion of the circumference of the outer contour being cut from the part.

32. The method of claim 31 further comprising at least a portion of the circumference of the large inner contour being cut from the part.

33. The method of claim 31 further comprising the cutting distance ds during the cutting of the small inner contour of the part is less than the cutting distance ds during the cutting of the outer contour of the part or the large inner contour of the part.

34. The method of claim 31 further comprising the cutting distance ds during the cutting of the small inner contour is between 40% and 80% of the cutting distance ds during the cutting of the outer contour of the part or of the large inner contour of the part.

35. The method of claim 31 further comprising the cutting speed v at which the plasma cutting torch is guided relative to the workpiece surface in the feed direction during the cutting of the small inner contour of the part is less than the cutting speed v during the cutting of the outer contour of the part or the large inner contour of the part.

36. The method of claim 35 wherein the cutting speed v at which the plasma cutting torch is guided relative to the workpiece surface during the cutting of the small inner contours of the part is between 20% and 80% of the cutting speed v during the cutting of the outer contour of the part or the large inner contour of the part.

37. The method of claim 31 further comprising first the small inner contour(s), then the large inner contour(s), and then the outer contour(s) of the part are cut.

38. A method for plasma cutting workpieces:
in which a plasma cutting torch which has at least one plasma torch body, an electrode, a nozzle and a secondary gas cap is used, wherein the part of the plasma cutting torch from which the plasma jet emerges from the secondary gas cap forms the plasma torch tip, and in which the plasma cutting torch is guided by means of a guidance system along a contour at a cutting speed v relative to the workpiece surface in the feed direction, and cuts a part from a workpiece;
wherein one of the composition, the volume flow, the mass flow, the pressure of a secondary gas SG flowing out of the secondary gas cap, and the cutting distance ds between the plasma torch tip and the workpiece surface, is changed, at the earliest, when a plasma jet hitting the workpiece surface has reached a position on the contour being cut out is one of:
the distance of which from a cut edge that is yet to be traversed is up to a maximum of 50% of a material thickness of the workpiece;
the distance of which from a cut edge that is yet to be traversed is up to a maximum of 25% of a material thickness of the workpiece;
the distance of which from a cut edge that is yet to be traversed is up to a maximum of 15 mm;
the distance of which from a cut edge that is yet to be traversed is up to a maximum of 7 mm; and
when a plasma jet hitting the workpiece surface contacts the cut edge.

39. The method of claim 38 further comprising the cut edge is created by cutting the same contour.

40. The method of claim 38 further comprising the secondary gas is one of air, oxygen, nitrogen, argon, hydrogen, methane, helium, and a mixture thereof.

41. The method of claim 38 further comprising changing one of the composition, the volume flow, the mass flow, and the pressure of the secondary gas SG flowing out of the secondary gas cap is implemented by one of connecting a gas or gas mixture, increasing the volume flow, increasing the mass flow, increasing the pressure of an oxidizing gas or gas mixture, and of reducing a gas or gas mixture.

42. The method of claim 41 further comprising the composition of the secondary gas is changed in such a manner that the increase in the proportion of the oxidizing gas or gas mixture or the reducing gas or gas mixture in the secondary gas is at least 10% by volume.

43. The method of claim 41 further comprising the increase in the volume flow, the mass flow, or the pressure of the oxidizing gas or gas mixture, or of the reducing gas or gas mixture in the secondary gas is at least 10%.

44. The method of claim 43 further comprising the oxidizing gas or gas mixture contains oxygen or air.

45. The method of claim 43 further comprising the reducing gas or gas mixture contains hydrogen or methane.

46. The method of claim 38 further comprising changing one of the composition, the volume flow, the mass flow, or the pressure of the secondary gas SG flowing out of the secondary gas cap is implemented by one of switching off, reducing the volume flow, reducing the mass flow, and reducing the pressure of nitrogen, argon, air, helium, or the mixture thereof.

47. The method of claim 46 further comprising the composition of the secondary gas is changed in such a way that the reduction in the proportion of the gases or the gas mixture in the secondary gas is at least 10% by volume.

48. The method of claim 46 further comprising the reduction in the volume flow, the mass flow, or the pressure of the gases or of the gas mixture in the secondary gas is at least 10%.

49. The method of claim 38 further comprising the cutting distance ds between the plasma torch tip and the workpiece surface is reduced.

50. The method of claim 45, characterized in that the cutting distance ds is reduced by at least 25% and/or at least 1 mm.

51. The method of claim 38 further comprising the cutting speed v at which the plasma cutting torch is guided relative to the workpiece surface is changed, at the earliest when the plasma jet hitting the workpiece surface has reached a position on the contour being cut out is one of:
the distance of which from the cut edge still to be traversed is up to a maximum of 50% of the material thickness of the workpiece;
the distance of which from the cut edge still to be traversed is up to a maximum of 25% of the material thickness of the workpiece;
the distance of which from the cut edge still to be traversed is up to a maximum of 15 mm;
the distance of which from the cut edge still to be traversed is up to a maximum of 7 mm; and
in which the plasma jet hitting the workpiece surface contacts the cut edge.

52. The method of claim 51 further comprising the cutting speed v is increased.

53. The method of claim 52 further comprising the cutting speed v is increased by at least 10%.
